(19) United States
(12) Patent Application Publication
(10) Pub. No.: US 2006/0044274 A1
(43) Pub. Date: Mar. 2, 2006

(54) Mouse device provided with image capturing device

(76) Inventors: Tatsuya Numazawa, Kanagawa (JP); Satoshi Shikaya, Kanagawa (JP); Tomonori Mitsui, Kanagawa (JP); Toshihiko Yasuma, Kanagawa (JP)

Correspondence Address: WHITHAM, CURTIS & CHRISTOFFERSON, P.C.;SUITE 340, 11491 SUNSET HILLS ROAD, RESTON, VA, 20190, US

(21) Appl. No.: 11/214,982

(22) Filed: Aug. 31, 2005

(30) Foreign Application Priority Data
Sep. 2, 2004 (JP) P2004-255964

(51) Int. Cl. G09G 5/08

(52) U.S. Cl. 345/163

(57) ABSTRACT

A mouse device is adapted to be connected to an information processing device. A case body has a bottom face formed with a recess. A coordinates information input device is provided on the bottom face of the case body to input coordinate information to the information processing device. An image capturing device is incorporated in the case body to capture an image of an object situated within an image capturing range. A stand is integrally provided on the bottom face of the case body and selectively placed in one of a first position housed within the recess and a second position withdrawn from the recess to fix the image capturing range.

### BACKGROUND OF THE INVENTION

This invention relates to a mouse device provided with an image capturing device, which is also used as a camera device.

In recent years, a simplified television conference system through Internet prevails. Correspondingly, as a computer peripheral device, a personal small-sized camera equipped with an image capturing device also prevails. For example, Japanese Patent Publication No. 2001-282452A discloses a hybrid device in which such a personal small-size camera is incorporated in a mouse device.

When such a mouse is employed as a coordinates information input device, the coordinates information is inputted while the mouse is moved on a plane. For this reason, the bottom of the mouse must be made flat.

On the other hand, when such a mouse device is employed as a camera device, in order to fix the image capturing area of the image capturing device, it is necessary to attach an individual fixing tool onto the bottom of the mouse device. It is troublesome for the user.

In addition, when the above functions of the mouse device are switched to each other, a user must carry out a changeover operation to respective application softwares for the coordinates information inputting function and the camera function. It is troublesome for the user.

### SUMMARY OF THE INVENTION

It is therefore an object of the invention to provide a mouse device provided with an image capturing device, in which the coordinates information inputting function and the camera function can be switched to each other while maintaining workability.

In order to achieve the above object, according to the invention, there is provided a mouse device adapted to be connected to an information processing device, comprising:

a case body, having a bottom face formed with a recess;

a coordinates information input device, provided on the bottom face of the case body to input coordinate information to the information processing device;

an image capturing device, incorporated in the case body to capture an image of an object situated within an image capturing range; and

a stand, integrally provided on the bottom face of the case body and selectively placed in one of a first position housed within the recess and a second position withdrawn from the recess to fix the image capturing range.

The mouse device may further comprise a sensor provided in the recess to detect whether the stand is placed in the first position. Here, the coordinates information input device is automatically activated while automatically deactivating the image capturing device, when the sensor detects that the stand is placed in the first position. On the other hand, the image capturing device is automatically activated while automatically deactivating the coordinates information input device, when the sensor detects that the stand is not placed in the first position.

The sensor may be a mechanical switch or an optical sensor.

The stand may be pivotably provided on the bottom face of the case body, so that the image capturing range is adjusted in accordance with a pivot angle of the stand.

The stand may be extensibly provided on the bottom face of the case body, so that the image capturing range is adjusted in accordance with an extended length of the stand.

A part of the case body may be tapered so as to form a slant face which is to be brought into contact with a face on which the mouse device is placed, when the stand is placed in the second position. Here, a rubber pad may be provided on the slant face.

With the above configuration, the image capturing area can be adjusted and fixed without troublesome operation such as preparation of an individual fixing tool. Further, the coordinates information input function and the image capturing function can be switched with improved workability.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a top view of a mouse device according to a first embodiment of the invention;

FIG. 2 is a bottom view of the mouse device of FIG. 1, showing a state that a stand is housed in a case body;

FIG. 3 is an enlarged perspective section view showing a portion where the stand is attached to the case body of the mouse device of FIG. 1;

FIG. 4 is a schematic view showing how to use the stand;

FIG. 5 is a bottom view of the mouse device of FIG. 1, showing a state that the stand is used;

FIG. 6 is an enlarged perspective section view showing a sensor switch of the mouse device of FIG. 1;

FIG. 7A is an enlarged perspective section view of a first modified example of the mouse device of FIG. 1;

FIG. 7B is an enlarged perspective section view of a second modified example of the mouse device of FIG. 1;

FIG. 8 is an enlarged side view showing a front end portion of the mouse of FIG. 1;

FIG. 9 is a side view showing a mouse device according to a second embodiment of the invention;

FIG. 10 is a bottom view of the mouse device of FIG. 9;

FIG. 11 is an enlarged section view showing a stand of the mouse device of FIG. 9; and

FIG. 12 is a bottom view of a modified example of the mouse device of FIG. 9.

### DETAILED DESCRIPTION OF THE EMBODIMENTS

Embodiments of the invention will be described below in detail with reference to the accompanying drawings.

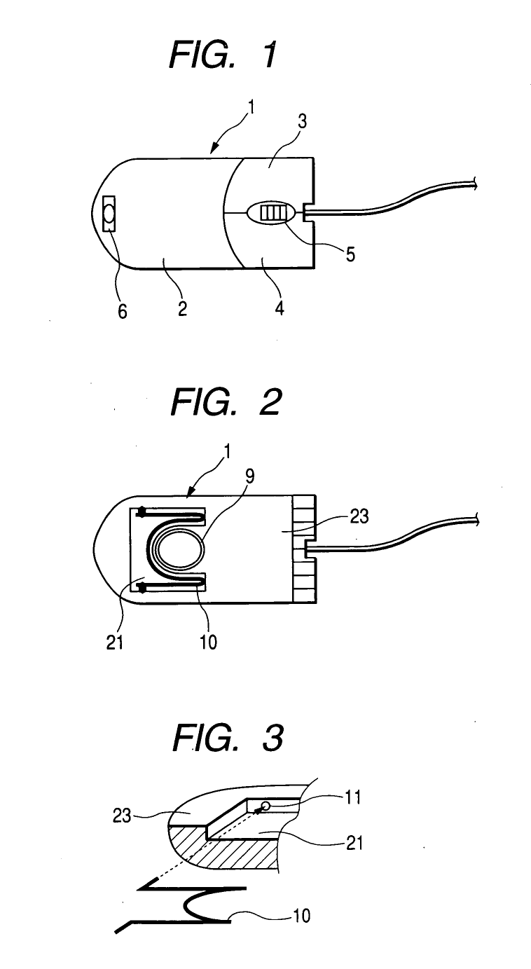

As shown in FIG. 1, a mouse device 1 according to a first embodiment comprises a case body 2 which has a size enough to be settled in a user's hand.

As shown in FIG. 2, the mouse device 1 further comprises an image capturing device 6 necessary for a camera function, and a pivotable stand 10 capable of adjusting an image capturing area of the image capturing device 6. A bottom face 23 of the case body 2 is formed with a recess 21 adapted to house the stand 10 in an non-use state. In the recess 21, a mechanical sensor switch 13 for detecting whether the stand 10 is housed in the recess 21 is provided. A part of a track ball 9 for inputting coordinates information is exposed on the bottom face 23 of the case body 2.

As shown in FIG. 1, the mouse device 1 further comprises a left click button 3 and a right click button 4 for making the operation such as clicking, double-clicking or drugging to be done by a user, and a scroll button 5 for making the operation such as scrolling and others. The function and operation of these left click button 3, right click button 4 and scroll button 5, which are well known, will not be explained in detail.

The mouse device 1 is connected to an information processing apparatus (not shown) such as a personal computer. In this case, the connection between the mouse device 1 and the information processing apparatus may be made by a cable relied on the USB standard or a wireless system as well as a dedicated mouse device cable.

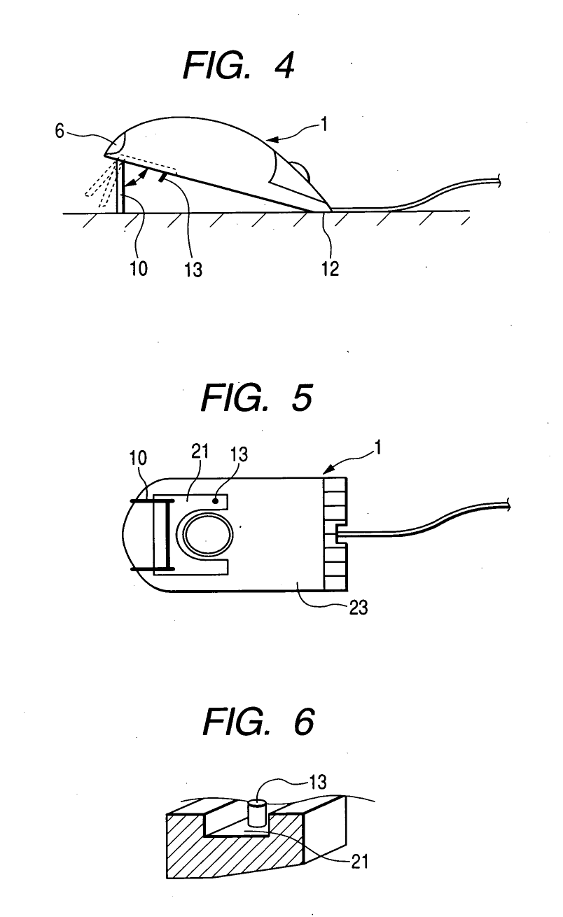

When the mouse device 1 is used as a camera device, the stand 10 is pivoted so as to be withdrawn from the recess 21 as shown in FIGS. 4 and 5. The mouse device 1 is laid on a desk or the like in this state, thereby fixing the image capturing area of the image capturing device 6.

The height of the image capturing area can be adjusted in accordance with the pivoting angle of the stand 10 as shown in dashed lines shown in FIG. 4. Therefore, the image capturing area can be easily adjusted without providing an individual fixing tool.

As shown in FIG. 3, the stand 10 is attached to the case body 2 by inserting both side ends of the stand 10 into holes 11 formed in the recess 21.

When the mouse device 1 is used as a coordinates information input device, the stand 10 is pivoted so as to be housed in the recess 21, thereby making the bottom of the mouse device 1 flat.

As shown in FIG. 8, a front end portion of the case body 2 is tapered to form a slant face 12. A slant angle 24 of the slant face 12 is set within a range of 15 to 45 degrees. When the mouse device 1 is used as the camera device, the desk face or the like and the slant face 12 are brought into contact with each other, thereby improving the stability of the mouse device 1.

Further, a rubber pad 20 is provided on the slant face 12 for preventing slippage, the installing stability of the mouse device 1 can be further assured. When the mouse device 1 is used as the coordinates information input device, since the rubber pad 20 will not be brought into contact with the desk face or the like, the mouse device 1 can be smoothly slid on the desk face or the like without any interference.

The detection of the status of the stand 10 through the use of the mechanical sensor switch 13 will be explained with reference to FIG. 6.

When the stand 10 is housed in the recess 21, the sensor switch 13 is depressed by the stand 10, thereby opening or closing internal contact (not shown). The housed state of the stand 10 is thus detected. To the contrary, when the stand 10 is withdrawn from the recess 21, the depressed state of the sensor switch 13 is released, thereby detecting the withdrawn state of the stand 10.

When the housed state of the stand 10 is detected by the sensor switch 13, the mouse device 1 automatically deactivate the camera function (application) and activate the coordinates information input function (application). To the contrary, when the withdrawn state of the stand 10 is detected by the sensor switch 13, the mouse device 1 automatically deactivate the coordinates information input function and activate the camera function.

In this embodiment, the mechanical switch is used as the sensor switch 13. However, an optical sensor switch of transmissive type or reflective type may be alternatively used.

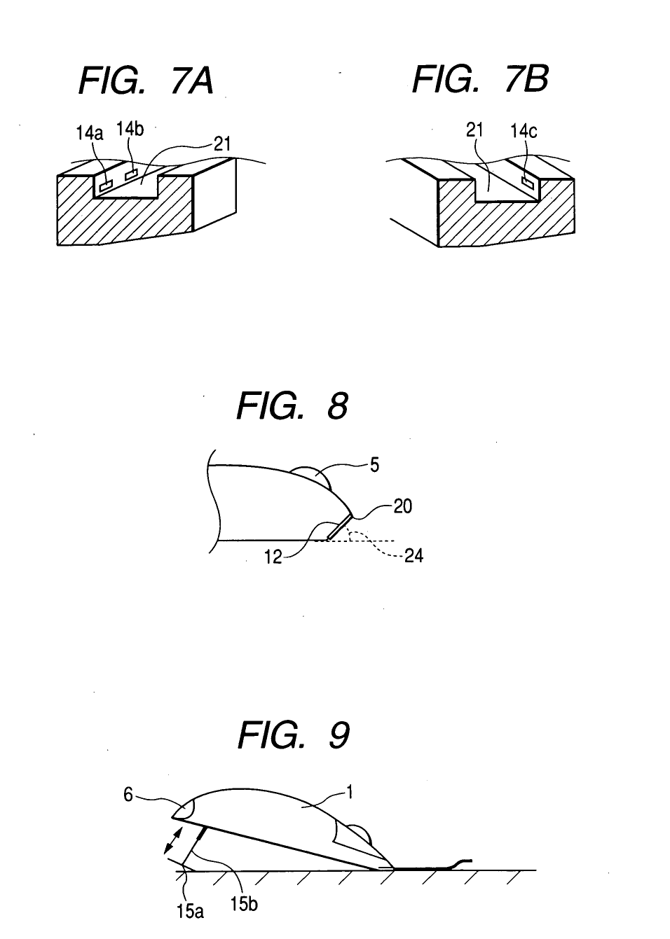

Specifically, in a case where the reflective type optical sensor is used as shown in FIG. 7A, the housed state of the stand 10 can be detected when a light detector 14b detects infrared light which is emitted from a light emitter 14a and reflected by the stand 10.

In a case where the transmissive type optical sensor is used as shown in FIG. 7B, the withdrawn state of the stand 10 can be detected when a light detector 14c detects infrared light which is emitted from a light emitter (not shown).

A mouse device according to a second embodiment of the invention will be described with reference to FIGS. 9-11. Components similar to those in the first embodiment will be designated by the same reference numerals and repetitive explanations for those will be omitted. In this embodiment, an extensible stand is used. The image capturing area of the image capturing device 6 can be easily adjusted by extending or contracting the stand without providing an individual fixing tool.

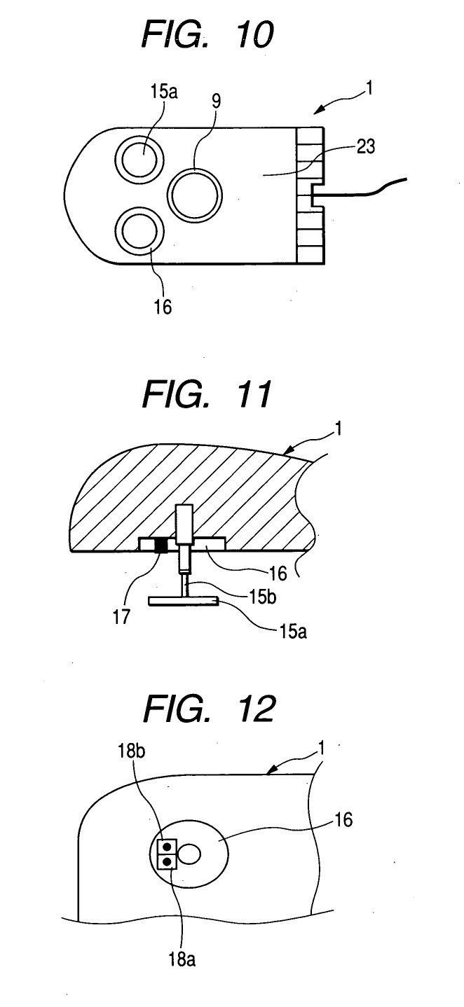

Specifically, as shown in FIGS. 10 and 11, the extensible stand is composed of a stand bottom 15a and an extensible rod 15b. When the rod 15b is contracted so that the stand bottom 15a is housed in a recess 16 formed on the bottom face 23, a mechanical sensor switch 17 disposed in the recess 16 is depressed by the stand bottom 15a.

Upon the depression of the sensor switch 17 by the stand bottom 15a, the housed state of the stand is detected. Accordingly, the mouse device 1 automatically deactivates the camera function and activates the coordinates information input function.

When the stand bottom 15a is withdrawn from the recess 16, the depressed state of the sensor switch 17 is released, thereby detecting the withdrawn state of the stand. Accordingly, the mouse device 1 automatically deactivates the coordinates information input function and activates the camera function.

As shown in FIG. 12, an optical sensor may be used as the sensor switch in place of the above mechanical sensor switch 17.

Specifically, the housed state of the extensible stand can be detected when a light detector 18b detects infrared light which is emitted from a light emitter 18a and reflected by the stand bottom 15a. Therefore, the size of the stand bottom 15a is determined so as to have an enough size to certainly reflect the infrared light emitted from the light emitter 18a toward the light detector 18b.

The size of the stand bottom 15a is determined so as to be smaller than the size of the recess 16 because the stand bottom 15a must be entirely housed within the recess 16 (the bottom face 23 of the case body 2 must be made flat) when the mouse device 1 is used as the coordinates information input device. For the same reason, the depth of the recess 16 is determined such that the stand bottom 15a is entirely housed within the recess 16 when the stand bottom 15a depresses the sensor switch 17.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A mouse device adapted to be connected to an information processing device, comprising:
a case body, having a bottom face formed with a recess;
a coordinates information input device, provided on the bottom face of the case body to input coordinate information to the information processing device;
an image capturing device, incorporated in the case body to capture an image of an object situated within an image capturing range; and
a stand, integrally provided on the bottom face of the case body and selectively placed in one of a first position housed within the recess and a second position withdrawn from the recess to fix the image capturing range.

2. The mouse device as set forth in claim 1, further comprising a sensor provided in the recess to detect whether the stand is placed in the first position, wherein:
the coordinates information input device is automatically activated while automatically deactivating the image capturing device, when the sensor detects that the stand is placed in the first position; and
the image capturing device is automatically activated while automatically deactivating the coordinates information input device, when the sensor detects that the stand is not placed in the first position.

3. The mouse device as set forth in claim 2, wherein the sensor is a mechanical switch.

4. The mouse device as set forth in claim 2, wherein the sensor is an optical sensor.

5. The mouse device as set forth in claim 1, wherein the stand is pivotably provided on the bottom face of the case body, so that the image capturing range is adjusted in accordance with a pivot angle of the stand.

6. The mouse device as set forth in claim 1, wherein the stand is extensibly provided on the bottom face of the case body, so that the image capturing range is adjusted in accordance with an extended length of the stand.

7. The mouse device as set forth in claim 1, wherein a part of the case body is tapered so as to form a slant face which is to be brought into contact with a face on which the mouse device is placed, when the stand is placed in the second position.

8. The mouse device as set forth in claim 7, wherein a rubber pad is provided on the slant face.
